(19) United States
(12) Patent Application Publication
(10) Pub. No.: US 2015/0286529 A1
(43) Pub. Date: Oct. 8, 2015

(54) MEMORY DEVICE HAVING CONTROLLER WITH LOCAL MEMORY

(71) Applicant: Micron Technology, Inc., Boise, ID (US)

(72) Inventor: Aron T. Lunde, Boise, ID (US)

(21) Appl. No.: 14/620,852

(22) Filed: Feb. 12, 2015

Related U.S. Application Data
(60) Provisional application No. 61/976,732, filed on Apr. 8, 2014.

(51) Int. Cl. G06F 11/10

(52) U.S. Cl. CPC G06F 11/1076

(57) ABSTRACT

Embodiments of memory devices, systems, and methods for operating a memory device with a controller having local memory are generally described herein. In some embodiments, the controller can distribute memory requests (e.g., read, write) to an appropriate module memory of the memory device and organize a response from the memory device to the host, including detection and correction using ECC data stored in the local memory. The local memory can also provide redundant memory for any defective module memory locations.

### RELATED APPLICATION

This application is based upon and claims the benefit of the priority of U.S. Provisional Patent Application Ser. No. 61/976,732, filed on Apr. 8, 2014, the disclosure of which is incorporated herein in its entirety by reference thereto.

### BACKGROUND

Memory bandwidth has become a bottleneck to system performance in high-performance computing, high-end servers, graphics, and mid-level servers. Microprocessor enablers are increasing cores and threads-per-core to greatly improve performance and workload capabilities by distributing work sets into smaller blocks and distributing them among an increasing number of work elements (e.g., cores). Since each computer element in a processor requires memory then having multiple computer elements per processor results in the need for an increase in the amount of memory needed per processor. This results in a greater need for memory bandwidth and memory density to be tightly coupled to a processor to address these challenges. Current memory technology roadmaps may not provide the performance to meet the central processing unit (CPU) and graphics processing unit (GPU) memory bandwidth goals.

To address the need for memory bandwidth and memory density to be tightly coupled to a processor, a hybrid memory cube (HMC) may be implemented so that memory may be placed on the same substrate as a controller enabling the memory system to perform its intended task more optimally. The HMC may feature a stack of individual module memory dies (e.g., memory devices) connected by internal vertical conductors, such as through-silicon vias (TSVs). TSVs are vertical conductors that can electrically connect a stack of individual memory dies with a controller. The HMC can provide a smaller form factor, deliver bandwidth and efficiencies while using less energy to transfer data per bit. In one embodiment of an HMC, the controller comprises a high-speed logic layer that interfaces with the vertical stacks of memory devices that are connected using the TSVs. The memory can handle the data, while the logic layer can handle memory control within the HMC. General needs exist for improved HMCs.

### BRIEF DESCRIPTION OF THE DRAWINGS

FIG. 1 illustrates a block diagram of an embodiment of a system.

FIG. 2 illustrates a block diagram of an embodiment of a memory device.

FIGS. 3A and 3B illustrate a side cross-sectional view and an orthographic view of an embodiment of a memory device in accordance with FIG. 1.

FIG. 4 illustrates a flowchart of an embodiment of a method for writing to the memory device having a memory manager with local memory.

FIG. 5 illustrates a flowchart of an embodiment of a method for reading from the memory device having a memory manager with local memory.

FIGS. 6A and 6B illustrate a side cross-sectional view and an orthographic view of an embodiment of a memory device in accordance with FIG. 1.

### DETAILED DESCRIPTION

The memory dies stacked on the HMC are complete memory devices such that each have their own redundant memory areas. Since the HMC construct includes a logic layer, the HMC is capable of performing error detection and correction. The opportunity then exists to use the HMC as a controller for multiple memory devices. Memory devices behind the HMC would not need redundant arrays, would not need to store error correction data and could be faster because they would not have to remap out bad memory cells. The host would receive error corrected data from the memory devices via the HMC. Any bits that were to fail in the memory devices behind the HMC could be detected and corrected using the HMC local memory. The HMC device, or a similar construct with both logic and memory function as described, would decrease complexity, increase quality and result in better system performance.

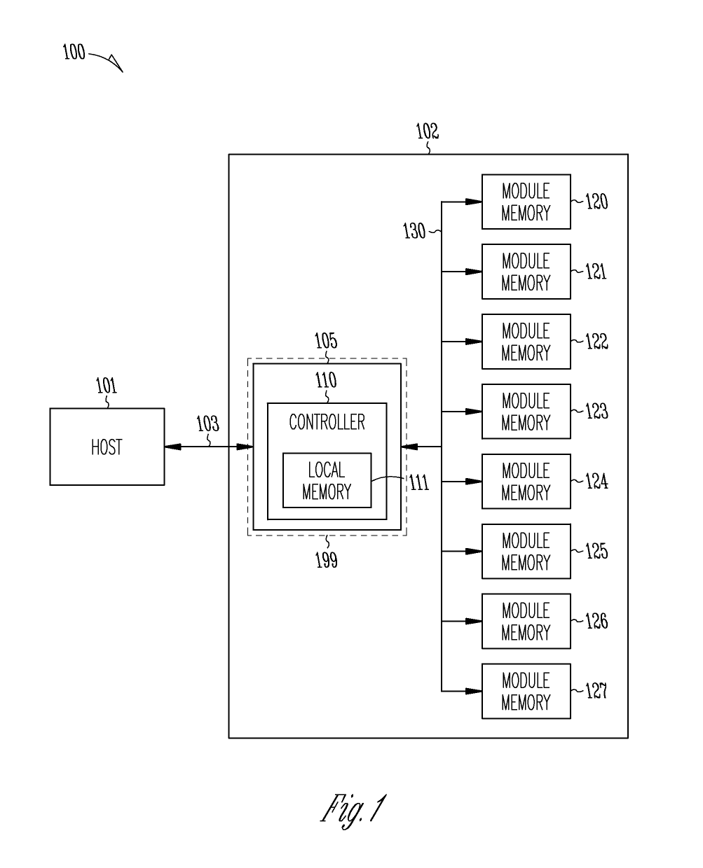

FIG. 1 illustrates a block diagram of an embodiment of a system 100. A host 101 (e.g., central process unit (CPU)) is coupled to a memory construct 102 over a bi-directional data link 103. The bi-directional data link 103 can include a serialize/deserialize (SERDES) data link or a parallel data link.

The memory construct 102 includes a controller 110 such as a controller 110 implemented in either an application specific integrated circuit (ASIC) 105 or a field programmable gate array (FPGA) 105. The ASIC/FPGA 105 can include other logic blocks corresponding to memory control and communication with the host 101. The ASIC/FPGA 105 can be used to enable customization for a particular use or be a processor (CPU). The controller 110 can include a processor (CPU), an ASIC, or other controlling circuitry. The ASIC/FPGA 105 and controller 110 may be attached to a unique substrate 199. The combination of the substrate 199, ASIC/FPGA 105, the controller 110, and the local memory may be part of a hybrid memory cube (HMC) memory device. There are constructs of the HMC that do not require substrate 199. Subsequent reference to the controller 110 may include the ASIC/FPGA 105.

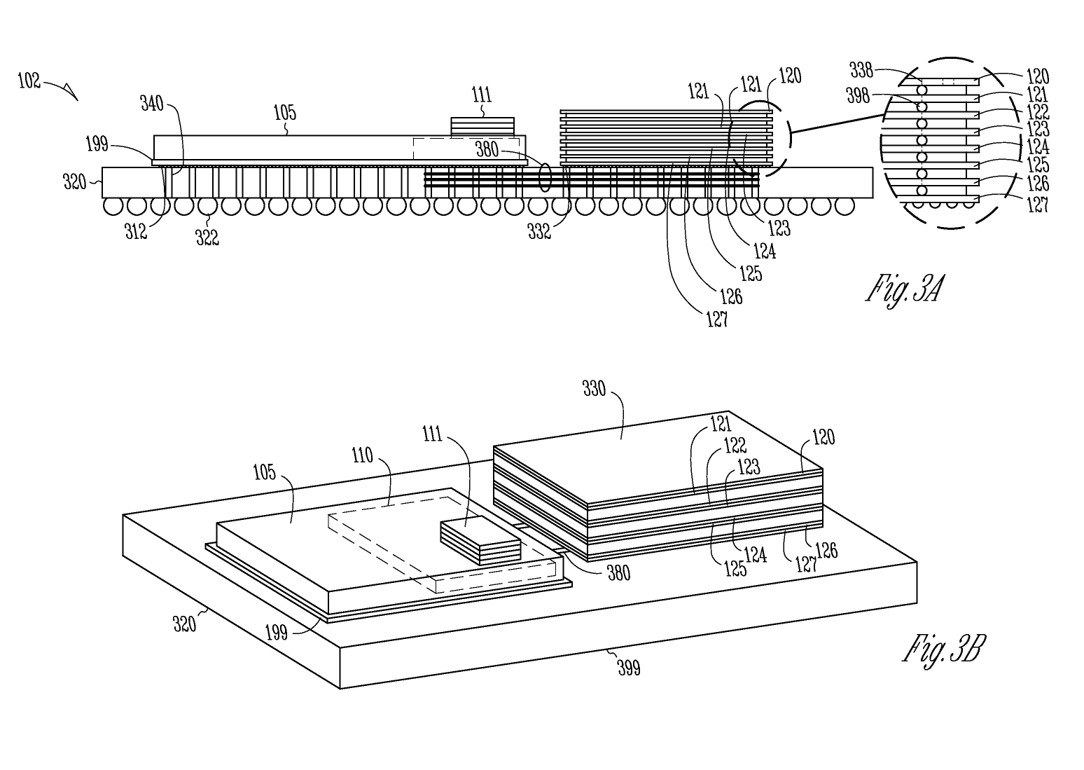

The memory construct 102 additionally includes a plurality of module memory 120-127 (e.g., memory dies). The module memory 120-127 can be in the form of stacked memory dies as seen subsequently with reference to FIGS. 3A and 3B. The module memory 120-127 can be any type of memory device including, but not limited to, volatile memory (e.g., dynamic random access memory (DRAM), static random access memory (SRAM)) or non-volatile memory (e.g., Flash, phase change memory (PCM)). Module memory 120-127 shown in FIG. 1 may include an additional layer for signal organization and/or buffering as part of a stack.

The module memory 120-127 can include any input/output (I/O) circuitry typically associated with memory devices in order for each module memory 120-127 to communicate with the controller 110 over a memory bus 130. Thus, the and/or the controller 110 can write data for storage to a particular module memory 120 over the bus and that particular module memory 120 can use its associated I/O circuitry to accept the data and store it in the module memory 120. Similarly, the and/or the controller 110 can read data from that particular module memory 120 and the I/O circuitry of that module memory 120 can access the memory array to retrieve the addressed memory location(s).

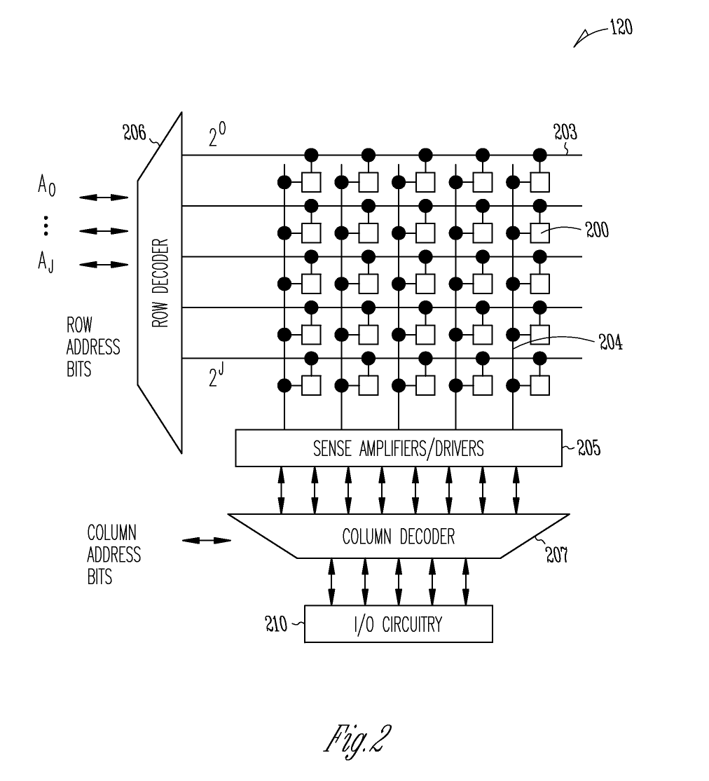

FIG. 2 illustrates a block diagram of one of the module memory devices 120 of the memory construct 102 of FIG. 1. The other memory devices 121-127 are substantially similar. The block diagram is of a DRAM for purposes of illustration only since the present embodiments are not limited to any one memory type.

The memory device comprises a plurality of memory cells 200 (e.g., an array of memory cells), each memory cell 200 being coupled between an access line (e.g., word line) 203 and a data line (e.g., digit line) 204.

The data lines 204 are coupled to sense circuits/drivers 205 that can sense the states of the memory cells 200. The sensing can occur through sense circuits 205 when the memory cell capacitors are coupled to the data lines through their respective enabled activation devices.

A row decoder 206 is coupled to the access lines 203 to generate the access line signals in response to a row address from the controller 110 of FIG. 1. A column decoder 207 is coupled to the sense circuits/drivers 205 and generates a column address through drivers onto the data lines 204 in response to a column address from the controller 110. The column decoder 207 also outputs the sensed states from the memory cells 200 as well as accepts the data to be stored in the memory cells 200.

The outputs from the column decoder 207 are input to the input/output (I/O) circuitry 210. The I/O circuitry 210 can include data pad I/O circuitry.

Referring again to the system 100 of FIG. 1, in order to reduce the size of the module memory 120-127 from that of a typical memory die, the module memory 120-127 do not need to include the normal redundant memory areas and no module memory 120-127 area need be dedicated to storing error correction data. Both of these details are typically found in prior art memory dies and module constructs. The redundant memory area needs of the module memory 120-127 can be met by the local memory 111 and the memory area needed for storing error correction data can also be served by local memory 111. The ECC circuitry is located in the controller 110 which removes the need for ECC circuitry on the host.

The controller 110 includes local memory 111 that can be used as redundant memory and ECC memory for the module memory 120-127. The local memory 111 can be stacked memory as illustrated in FIGS. 3A and 3B and can include any type of memory technology or combinations of different types of memory technologies. For example, the local memory 111 can be non-volatile memory (e.g, DRAM, SRAM) and/or volatile memory (e.g., Flash, PCM). The local memory 111 is not required to be stacked memory and can exist as a single memory layer. The local memory 111 may be part of the controller 110.

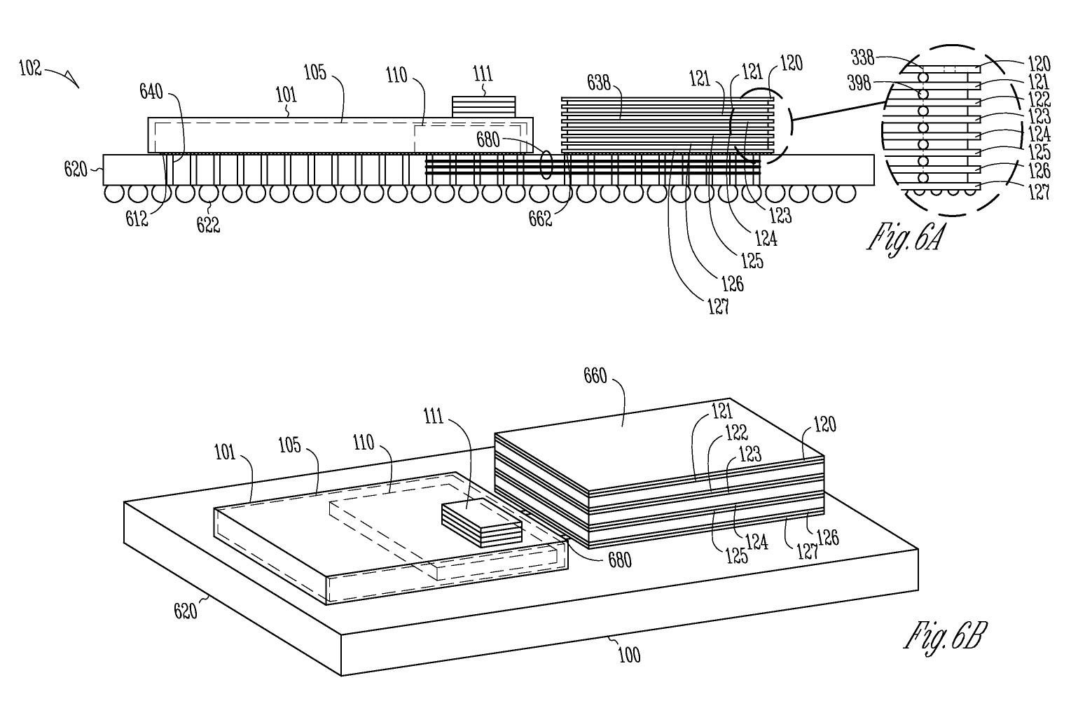

FIGS. 6A and 6B illustrate a diagram of an embodiment of the system 100 where the host 101 has absorbed the functionality of the controller 110. In such a case the local memory 111 may be stacked on the host 101 complete with the controller 110. Thus, a multi-chip memory (MCM) memory stack 630 may talk directly to the host 101 which has absorbed the functionality of the controller 110. The MCM memory stack 630 is not required to be stacked memory and can exist as a single memory layer.

The MCM memory stack 630 can include multiple memory dies 120-127 that are stacked using through-silicon vias (TSVs) 638. Signals from the connections 612 of the ASIC/FPGA 105 and the connections 632 of the MCM memory stack 630 flow into and through traces 680 and vias 640 typical of an MCM substrate 620. Other signals from either the ASIC/FPGA 105 or MCM memory stack 630 that need to connect to the computer system through solder balls 622 can use traces 680 and vias 640 typical of an MCM substrate 620. The memory construct 102 can provide a specialized electronic package where multiple integrated circuits (ICs), semiconductor dies or other discrete components are packaged onto a unifying substrate, thereby facilitating their use as a component (e.g., appearing as one larger IC). The ASIC/FPGA 105 can also include logic to provide host interface logic for processing signals between the host (e.g., host 101 of FIG. 1) and the MCM memory stack 630 and control logic for controlling the MCM memory stack 630.

FIGS. 3A and 3B illustrate a diagram of an embodiment of the memory construct 102 where the controller 110 and the local memory 111 (a construct typical of a hybrid memory cube) are combined with MCM memory 330 all on a substrate 320 to form an (MCM) Module 399 that can be individually tested and qualified prior to being placed on a main board to talk with a host 101 via a bi-directional data link 103.

The local memory 111, along with the controller 110, may handle data and memory control of the MCM memory 330. The TSVs 338 can provide a high level of concurrent connections. Memory access by the controller 110 can be carried out over an interface 380 between the MCM memory 330 and the ASIC/FPGA 105 that can support relatively high transfer rates (e.g., greater than 1 Tb/s). For example, the interface 380 can be a high speed serial bus. The TSVs 338 may be coupled with interconnections 398 between layers.

MCM memory stack 330 may represent the plurality of module memory 120-127. MCM memory stack 330 may look like it is made up of multiple autonomous partitions (e.g. 16 partitions). Each partition can include multiple independent memory banks, (e.g., 2 to 8). Each partition can be independent of the other partitions and autonomous in terms of data movement and command/addressing during normal operation. In other embodiments, the MCM memory stack 330 depicted in FIG. 3A, FIG. 3B, FIG. 6A and FIG. 6B may include an additional layer for signal organization and/or buffering as part of a stack.

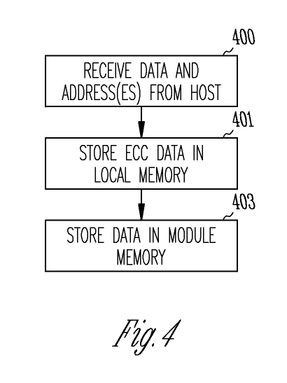

FIG. 4 illustrates a flowchart of an embodiment of a method for writing to (e.g., programming) the memory device having a controller with local memory. Data with one or more addresses (e.g., logical addresses) can be received with a write command from the host (e.g., CPU) 400 coupled to the memory device. For example, the host might transmit data with a single address, a plurality of addresses, or a burst of data with a beginning address to be stored in a plurality of consecutive locations in the module memory.

The data can be a payload of a data packet (e.g., user data) that comprises error correction code (ECC) data. The ECC data can be generated by the host using an ECC algorithm (e.g., Hamming, Reed-Solomon, Viterbi) and the resulting ECC data attached to the payload data to form the data packet. The host can then transmit the data packet to the memory device. The ECC data may also be generated by the controller, ASIC, FPGA and/or circuits on memory devices.

The controller stores the ECC data in a location of the local memory 401 that is associated with the destination address of the data packet in the module memory. The controller stores the data packet (user data) from the host to the appropriate module memory 403 as indicated by the received address(es).

Storing the ECC data in the local memory can free up the module memory to hold more data. In another embodiment, storing the ECC data in the local memory enables the module memory die to be made smaller.

The controller can write the data packet to the module memory using the logical address received from the host and let the module memory determine the physical address for the data. The controller 110 knowing how the module memory remaps the logical address to the physical address may also be useful. In another embodiment, the controller can determine a physical address to be associated with the logical address and write the data to that physical address. Having the controller 110 understand the physical address provides the controller 110 with the capability of mapping defective memory locations to a physical address in the local memory. The controller can maintain the memory map for the local memory being used for module memory redundancy.

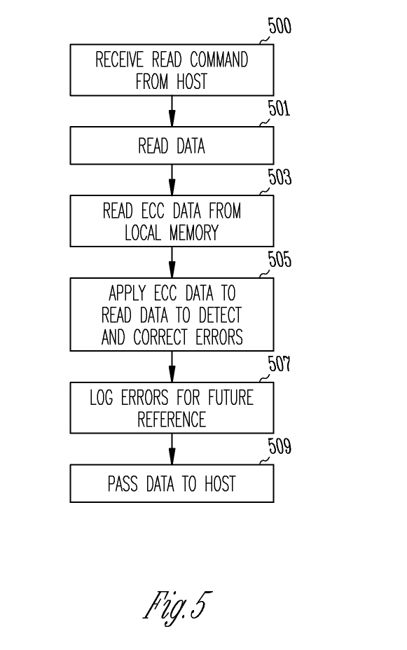

FIG. 5 illustrates a flowchart of an embodiment of a method for reading from the memory device having a controller with local memory. While reading from either the module memory or the local memory as redundant memory, the controller can perform both error detection and error correction on the data using ECC data stored in the local memory. Some data may have too many errors to be correctable by the ECC data. In this case, the data can be marked as unusable, an error message generated, or the data is simply not used.

A read command is initially received from the host 500. The read command includes the address (e.g., logical address) to be accessed. The controller can then read the user data from the physical address associated with the received logical address 501. Thus, if the memory module had originally written the data to the module memory associated with that logical address, the controller can read the data from the physical address in the module memory. If the controller had remapped the logical address to the local memory acting as redundant memory (due to a defective module memory location), the controller can access the physical address in the local memory.

It takes time to retrieve data from module memory. In industry standard module memories it is typical to further delay the data being retrieved by forcing the module memory to identify, decode and block bad memory locations as well as to recover data from redundant memory area inside the module memory. In one embodiment of this invention the module memory is not required to identify, decode, or block bad memory locations—nor does it retrieve data from redundant module memory area. The module memory is capable of operating at its maximum speed bringing out good and bad data. The time it takes to retrieve redundant module memory data from the local memory is shorter than the time it takes for the module memory to respond with good and bad data while operating at maximum speed. The controller 110 prepares the local memory data, which is serving as the module memory redundancy, prior to the arrival of the good and bad data from the module memory operating at maximum speed, so that the useful module memory data can merge without delay resulting in the fastest possible response to the host.

The controller 110 can also read the ECC data that was stored in the local memory 503 and apply the ECC data to the user data read from the module memory in order to detect if the read data contains one or more errors 505. The controller 110 can use the ECC data to attempt to correct the one or more errors. The controller 110 can use the same ECC algorithms mentioned previously (e.g., Hamming, Reed-Solomon, Viterbi).

If the controller 110 or ASIC/FPGA 105 detects that the user data read from the module memory contains one or more errors, the controller 110 or ASIC/FPGA 105 logs the error for future reference 507. The controller 110 or ASIC/FPGA 105 can then pass the correct data on to the host 509.

The controller 110 can map any further accesses to the defective location of the particular module memory or the local memory to a redundant memory location in the local memory 111. Either the controller 110, the local memory 111, the ASIC/FPGA 105 or the module memory can keep a list of the defective locations. During idle time the host (CPU) 101, the controller 110 or ASIC/FPGA 105 can execute a repair function to use memory elements (i.e. redundant rows, redundant columns, redundant TSV, redundant blocks, etc.) to replace bad module memory or local memory elements. Alternatively the host (CPU) 101, the controller 110 or ASIC/FPGA 105 can trigger the repair procedure. Once the defective elements are repaired, the controller can remap future accesses to the operational redundant element.

The local memory can also be used as overflow memory for the module memory. For example if the module memory becomes full, the controller can remap incoming data to the local memory as back-up until locations in the module memory become free.

### CONCLUSION

The disclosed embodiments provide a controller with local memory that can act as an interface between a memory device and a host. The controller 110 can distribute memory requests (e.g., read, write) to the appropriate module memory and organize the response (e.g., error detection/correction) from the memory device to the host. The controller 110 can store the received ECC data in the local memory during a write operation and use the stored ECC data during a read operation to detect and/or correct data errors resulting from the module memory. The local memory can also provide redundant memory associated with defective locations of the plurality of module memories and error correction code memory associated with the plurality of module memories.

What is claimed is:

1. A memory construct, comprising:
a substrate;
a plurality of module memory devices coupled to the substrate; and
a controller coupled to the substrate and comprising local memory, separate from the plurality of module memory devices, that includes redundant memory associated with defective locations of the plurality of module memories and error correction code memory associated with the plurality of module memory devices.

2. The memory construct of claim 1, wherein the plurality of module memory devices are coupled together by through silicon vias.

3. The memory construct of claim 2, wherein the plurality of module memory devices are coupled to the controller through an interface in the substrate.

4. The memory construct of claim 1, wherein the local memory comprises a stack of local memory connected to the controller.

5. The memory construct of claim 4, wherein the local memory comprises a plurality of non-volatile memory dies and/or a plurality of volatile memory dies.

6. The memory construct of claim 1, wherein the plurality of module memory devices is one of a plurality of non-volatile memory dies or a plurality of volatile memory dies.

7. The memory construct of claim 1, wherein the controller is configured to receive data, comprising error correction code (ECC) data and user data, from a host coupled to the memory device, store the user data in the plurality of module memory devices and store the ECC data in the local memory.

8. The memory construct of claim 7, wherein the controller is configured to read the user data from the plurality of module memory devices, determine if the read user data comprises errors based on the ECC data stored in the local memory, and attempt to correct any detected errors using the ECC data.

9. The memory construct of claim 1, wherein the controller is configured to distribute requests from a host, coupled to the memory device, to the plurality of module memory devices and organize responses from the plurality of module memory devices to the host.

10. The memory construct of claim 1, wherein the plurality of module memory devices do not include redundant memory areas or error correction data areas.

11. A method for operating a memory construct having a controller, the method comprising:
receiving a write command from a host, the write command comprising user data and error correction code (ECC) data;
storing the ECC data in local memory of the controller; and
storing the user data in module memory of the memory construct wherein the module memory is separate from the local memory.

12. The method of claim 11, further comprising:
receiving a read command from the host;
reading user data from the module memory;
using associated ECC data in the local memory to detect any errors in the read user data; and
attempting to correct the detected errors with the ECC data in the local memory.

13. The method of claim 12, further comprising transmitting corrected data to the host in response to the read command.

14. The method of claim 12, further comprising logging an address associated with user data in which an error was detected.

15. The method of claim 14, further comprising attempting to repair a memory cell located at the address associated with the user data in which the error was detected during idle times of the controller.

16. The method of claim 14, further comprising attempting to repair the address associated with the user data in which the error was detected during idle time of the module memory associated with the address.

17. A method for operating a memory construct having a controller, the method comprising:
receiving a read command from a host, the read command comprising an address associated with data to be read from module memory separate from local memory of the controller;
reading error correction code (ECC) data, associated with the read data, from the local memory;
detecting, in response to the ECC data from the local memory, whether the read data comprises an error; and
attempting to correct the error in the read data with the ECC data from the local memory.

18. The method of claim 17, further comprising when the read data comprises the error, remapping, to the local memory, accesses to the address of the module memory.

19. The method of claim 18, further comprising:
repairing the module memory associated with the address; and
remapping, from the local memory to the module memory, accesses to the address after repair of the module memory associated with the address.

20. The method of claim 17, further comprising transmitting the read data to the host.

21. The method of claim 17, further comprising remapping, to the local memory, accesses to the address of the module memory when the module memory cannot store more data.

22. The method of claim 17, further comprising:
the controller distributing requests from the host to the module memory;
the controller organizing a response from the module memory to the host; and
transmitting the response to the host.

23. A system comprising:
a host; and
a memory construct coupled to the host, the memory construct comprising:
a substrate;
a module memory device coupled to the substrate; and
a controller coupled to the substrate and comprising local memory, separate from the module memory device, that includes redundant memory associated with defective locations of the module memory and error correction code (ECC) memory for storing ECC data associated with user data stored in the module memory device.

24. The system of claim 23, wherein the memory construct comprises a hybrid memory cube.

25. The system of claim 23, wherein the controller is part of an application specific integrated circuit (ASIC) or field programmable gate array (FPGA) coupled to the substrate.

26. The system of claim 25, wherein the ASIC or the FPGA and the module memory device are coupled with each other through an interface in the substrate.

27. The system of claim 23, wherein the module memory device and the local memory comprise dynamic random access memory.

28. The system of claim 23, wherein the host is coupled to the memory construct through a serial link.

29. The system of claim 23, wherein the host and controller are a single application specific integrated circuit coupled to the substrate.

30. The system of claim 23, wherein the module memory device is a single layer.

31. A method comprising:
receiving a command from a host that is separate from a memory construct having a controller that is coupled to a substrate with module memory separate from the controller, the controller receiving the command, the command comprising user data;
receiving error correction code (ECC) data from the controller or memory circuits;
storing the ECC data in local memory that is part of the controller; and
storing the user data in the module memory.

32. The method of claim 31, wherein storing the user data in the module memory comprises the controller communicating with the module memory over a serial link in the substrate.
